(19) United States
(12) Patent Application Publication
(10) Pub. No.: US 2005/0172861 A1
(43) Pub. Date: Aug. 11, 2005

(54) Plastic resin delivery and dispensing system for fluid concrete admixtures

(76) Inventor: Zachary T. Rich, Lambertville, NJ (US)

Correspondence Address: MATHEWS, SHEPHERD, MCKAY, & BRUNEAU, P.A., 100 THANET CIRCLE, SUITE 306, PRINCETON, NJ, 08540, US

(21) Appl. No.: 11/055,364

(22) Filed: Feb. 10, 2005

Related U.S. Application Data
(60) Provisional application No. 60/543,466, filed on Feb. 10, 2004.

(51) Int. Cl. C04B 7/00

(52) U.S. Cl. 106/638

(57) ABSTRACT

A method and device for delivery of a semi-fluid or fluid concrete admixture for a concrete mix to be mechanically agitated for recycling concrete is described. A hollow capsule body is at least partially filled with the admixture. The mechanical agitation of the concrete mix breaks said hollow capsule body releasing the admixture. Once the capsule containing the admixture enters a concrete mix and the concrete mix is agitated mechanically such as via a concrete ready-mix truck, the plastic resin delivery and dispensing capsule shatters and breaks down unnoticeable to the unaided eye, releasing the encapsulated admixture into the concrete mix.

### CROSS REFERENCES TO RELATED APPLICATIONS

This application is a Continuation-In-Part U.S. patent application Ser. No. ______, entitled Plastic Resin Delivery And Dispensing System For Fluid Concrete Admixtures, filed on Feb. 10, 2005, which claims the benefit under 35 U.S.C. 119(e) of U.S. Provisional Application Ser. No. 60/543,466, entitled Plastic Resin Delivery and Dispensing System for Fluid Concrete Admixtures, filed on Feb. 10, 2004.

### FIELD OF THE INVENTION

This invention relates to concrete admixture delivery and more particularly to a container and method for concrete admixture delivery.

### BACKGROUND OF THE INVENTION

Concrete admixtures modify the properties of concrete during and after manufacturing. Concrete admixtures help concrete achieve higher quality, maintain consistent concrete quality throughout the mix, and can be added when emergency situations arise. Liquid admixtures including, but not limited to, retarders or delay setting chemicals, air entrainers, air detrainers, accelerate setting, corrosion inhibitors, admixtures to reduce potential for alkali aggregate reactivity, bonding admixtures, water-reducers, super plasticizers (high range water reducers), natural and synthetic coloring admixtures, damp proofing, shrinkage reducing admixtures, anti-washout admixtures, hydration stabilizing or extended set retarding admixtures, grouting agents, gas forming agents, permeability reducers, fibers, pumping aids and others have become staples in admixtures.

It is important that the concrete be dosed with the correct amount of admixture because too little admixture may not impact the entire mix and too much admixture can overwhelm and have adverse effects on the concrete mix. The correct measurement of the volume of admixture added to the concrete mix is crucial and varies in each situation with all of the variables involved.

Concrete is returned by the customer to the ready-mix producer everyday. Customers must order enough concrete to pour a job, and this circumstance results in excess concrete being ordered to ensure a sufficient amount. The customer still purchases the entire order even though a portion may not be poured. Ultimately, the producer must ascertain what to do with leftover concrete within its useful life.

Concrete, without the use of a retarding admixture, should be poured within an hour to an hour and a half of production. Leftover concrete cannot sit in a ready-mix truck barrel as it will harden, and the useful choices degrade as the concrete hydrates, or begins to set. There are a few options ready-mix producers implement to utilize returned concrete.

There is a need for a simplified delivery solution to introducing pre-measured admixtures into concrete with a dispensing package that is not temperature sensitive to melting or freezing, maintains durable and strength qualities while the package is in shipping or being carried, and which essentially breaks down unnoticeable to the unaided eye in the concrete mix thereby releasing a pre-measured liquid admixture into a concrete mix.

### SUMMARY OF THE INVENTION

The present invention is a method and device for delivery of a semi-fluid or fluid concrete admixture for a concrete mix to be mechanically agitated for recycling concrete. A hollow capsule body is at least partially filled with the admixture. The mechanical agitation of the concrete mix breaks said hollow capsule body releasing the admixture.

### BRIEF DESCRIPTION OF THE DRAWINGS

A more complete understanding of the present invention may be obtained from consideration of the following description in conjunction with the drawings in which:

FIG. 1 is a perspective view of the Delivery And Dispensing Capsule;

FIG. 2 is a cross-section side view of the Delivery And Dispensing Capsule;

FIG. 3 is a diagrammatic representation of the process for recycling concrete; and,

FIG. 4 is a chart of admixture dosing.

### DETAILED DESCRIPTION OF VARIOUS ILLUSTRATIVE EMBODIMENTS

Although the present invention is particularly well suited for the delivery and dispensing of fluid concrete admixtures and shall be so described herein, it is equally well suited for the delivery of semi-fluid concrete admixtures and a variety of other concrete admixtures.

Concrete is returned by the customer to the ready-mix producer everyday. Customers must order enough concrete to pour a job, and this circumstance results in excess concrete being ordered to ensure a sufficient amount. The customer still purchases the entire order even though a portion may not be poured. Ultimately, the producer must ascertain what to do with leftover concrete within its useful life.

Concrete, without the use of a retarding admixture, should be poured within an hour to an hour and a half of production. Leftover concrete cannot sit in a ready-mix truck barrel as it will harden, and the useful choices degrade as the concrete hydrates, or begins to set. There are a few options ready-mix producers implement to utilize returned concrete.

A method of recycling returned concrete is pouring the leftover concrete into block forms. A ready-mix truck driver with leftover concrete can return to the batch plant and unload into 1/2 cubic yard block shape forms. The concrete blocks cost approximately $20 to produce (1 hour of labor), and can be sold for $35 per block. This method is labor intensive and requires more time than many ready-mix producers are willing to allocate. The market price of the concrete block results in a decreased value of the returned concrete. A further dilemma is the undersized market demand for the recycled concrete blocks.

Another method is pouring the returned concrete into batch plant waste piles, only to be crushed for fill. These large piles are crushed at an approximate cost of $3.50 per ton and then sold for as high as $6.75 per ton. The problems with this method include space for waste concrete dumping, environmental implications of dumping concrete into large piles, and most importantly, ground water runoff contamination. When waste concrete is unloaded, the driver must clean out the inside of the truck barrel and wash off the chutes and truck to prevent concrete from hardening on equipment. This contaminated high alkali water infiltrating the ground is causing the EPA to impose strict regulations on ready-mix producers, and further limits their options.

An additional method of recycling returned concrete is loading fresh concrete on top of the returned concrete mix at the batch plant. The returned concrete batch mixes with the fresh concrete in the ready-mix truck and is poured on the following jobsite. The problem is the returned concrete is typically old and setting up prior to the time it will be poured. The recycling process begins with concrete being initially produced, shipped to a jobsite, not utilized on the pour, shipped back to the batch plant, fresh concrete loaded on top, shipped to the next jobsite, and poured on the job. As the returned concrete batch ages it starts to hydrate, harden, and deteriorates in quality. This can lead to product problems, high repair costs, and waste by having to remove and re-pour the concrete. The problems and potential liabilities of this method generally outweigh the benefit of trying to recycle returned concrete at the market value of fresh concrete.

A further method of recycling returned concrete stems from the previous method of adding fresh concrete to the returned concrete at the batch plant. A retarding admixture can be added to a concrete mix to extend the set time. This method involves the ready-mix driver returning to the batch plant and loading a retarding admixture with fresh concrete to the returned concrete. The problem is the retarding admixture affects the entire load, and not only the returned concrete. This is not a practical method, and a retarding admixture dosage rate for the returned load is miniscule throughout the entire concrete batch. The problems still remain with quality deterioration of the product, high repair costs, and waste by having to remove and repair the concrete.

The following potential methods are products and techniques that were developed for manners other than the present invention's method of recycling and re-selling leftover concrete, but could attempt to benefit from the advanced concepts of the present invention.

Presently, a method includes a tank mounted on a ready-mix truck filled specifically with a high range water reducing admixture. The said tank method is designed to be filled with a high range water reducer and used for a single, particular freshly batched concrete load size, and not for dispersing measured dosages of fluid or semi-fluid concrete admixtures across multiple loads. This method is an all-or-nothing release from the tank as the driver will release the high range water reducer into the mix while driving or at the jobsite prior to pouring the load. A driver does have a site gauge measuring the amount of admixture in the tank, but this is often vague and very hard to read; as it becomes cloudy, broken, or inaccurate. Another problem with this method is the ambiguity of the driver accurately dosing the concrete at his discretion. Further problems are that it can be costly to place, constantly fill, and maintain a tank on every truck in a fleet.

The present invention, Plastic Resin Delivery And Dispensing System For Fluid Concrete Admixtures is a capsule delivery system comprised of a plastic resin containing a pre-measured dosage of admixture. Once the capsule enters a concrete mix and the concrete mix is agitated mechanically via a concrete ready-mix truck, the plastic resin delivery and dispensing capsule shatters and breaks down unnoticeable to the unaided eye, releasing the encapsulated admixture into the concrete mix. The present invention also discusses modifying the properties of a concrete mix by introducing a plastic resin delivery and dispensing capsule designed to shatter and break down releasing the contained pre-measured dosage of admixture.

The present invention is a new plastic delivery and dispensing packaging system that releases pre-measured concrete admixture dosages to concrete mixes. The present invention resolves many of the stated problems with the packaging capsule being formed of plastic resin. The object of the plastic resin formed delivery and dispensing capsule is to provide an efficient and economical method of dosing concrete with a pre-measured amount of liquid admixture.

Accordingly, an object of the present invention is to provide a pre-measured amount of liquid concrete admixture encapsulated in a plastic resin container that will be added to a concrete mix. The plastic resin container will shatter and break down unnoticeable to the unaided eye once the concrete mix is agitated mechanically, thereby releasing the liquid admixture into the concrete mix.

Another object of the present invention is to have the unique ability of the delivery and dispensing capsule being made of a plastic resin that is not temperature sensitive to melting or freezing, and which maintains durability and strength qualities while being transported or carried. An objective of the plastic resin capsule containing a pre-measured dosage of liquid concrete admixture is very unique in that it will completely break down unnoticeable to the unaided eye in the concrete mix once agitated mechanically in a concrete mix. This is due to the plastic resin capsule having brittle-like qualities once the capsule begins to break and rupture.

A further objective of the present invention is that a plastic resin is utilized which allows remarkable performance that forms the capsule walls for the encased liquid admixture. The plastic resin allows the walls to be thinner and require less material than other potential materials. This advancement allows for a smaller amount of packaging material carrying the liquid admixture to be introduced into a varying amount of concrete mix.

Admixtures are used to modify the properties of concrete during and after the manufacturing of concrete. This is important because admixtures can help concrete achieve a higher quality concrete than concrete by itself, admixtures maintain consistent concrete quality throughout the mix, and admixtures can be added during emergency situations. Liquid admixtures including, but not limited to, retarders or delay setting chemicals, air entrainers, air detrainers, accelerate setting, corrosion inhibitors, admixtures to reduce potential for alkali aggregate reactivity, bonding admixtures, water-reducers, super plasticizers (high range water reducers), natural and synthetic coloring admixtures, damp proofing, shrinkage reducing admixtures, anti-washout admixtures, hydration stabilizing or extended set retarding admixtures, grouting agents, gas forming agents, permeability reducers, fibers, pumping aids and others have become staples in admixtures.

Dosing concrete with the correct amount of admixture is important because too little admixture may not impact the entire mix, but too much admixture can overwhelm and have adverse effects on the concrete mix. Correct measurement of the amount of admixture added to the concrete mix is crucial and can vary in each situation taking into consideration all of the variables involved.

A current method of introducing liquid or dry admixtures into concrete is with the concrete manufacturing batch plant. It can be very troublesome though to have a ready-mix truck pull under the batch plant chute, receive the needed admixture, pull out from under the batch plant, and wait while the admixture is mixed properly throughout the concrete mix. This is an inefficient method and requires too much time. Another problem is, admixture waste involved with the use of bulk blending stations to introduce admixtures in concrete mixes.

Another method of introducing admixtures is having tanks mounted on ready-mix trucks. High range water reducers can typically be added to a concrete mix in this manner. The problem with this method is the human guesswork and inefficiency involved with adding the proper amount of admixture.

Currently, there is a need for a viable, simplified delivery solution to introducing pre-measured liquid admixtures into concrete with a dispensing package that is not temperature sensitive to melting or freezing, maintains durable and strength qualities while the package is in shipping or being carried, but essentially breaks down unnoticeable to the unaided eye in the concrete mix due to it's brittleness once the packaging capsule is broken thereby releasing a pre-measured liquid admixture into a concrete mix.

The present invention uses a newly engineered device consisting of a plastic resin dispensing container and a pre-measured dosage of fluid or semi-fluid concrete admixture in the plastic resin dispensing container. The present invention could be made from, but not limited to, plastic resin, epoxy, polymer, or ceramic. The present invention could be made from, but not limited to, plastic resins such as polyethylene terephthalate (PET, PETE), high density polyethylene (HDPE), vinyl (Polyvinyl Chloride or PVC), low density polyethylene (LDPE), polypropylene (PP), polystyrene (PS), styrene (S), polyurethane elastomer, acrylic, thermoplastic hydrocarbon resin or a combination of the listed plastic resins. The uniqueness in the plastic resin formed for the delivering and dispensing capsule is that the plastic resin is a reversal of traditional theory. Typically, plastic resin is designed to be strong, tough and not able to break easily. The present invention is the opposite and calls for the development of a plastic resin that is durable as a whole, but once broken will shatter to unnoticeable pieces due to its brittle-like qualities. The plastic resin developed for the present invention is custom-blended, impact-adjusted crystal polystyrene. The hybrid resin consists of standard fillers blended into a basic polystyrene resin which separates and weakens the polystyrene molecule chains. One such suitable custom-blended, impact-adjusted crystal polystyrene is one produced by Lucent Polymers. The custom plastic resin has a 3 g/10 minutes melt flow (200° C., 5.0 kg), 2,300 @ yield, p.s.i. (Mpa) tensile strength, 290,000 p.s.i. (Mpa) flexural modulus, 1.08 specific gravity, and 0.004 in/in mold shrinkage. The hybrid plastic is strong enough to not break in shipping and transit, but is weak enough to break down unnoticeably in the concrete mix. Although polystyrene is the resin best chosen, other plastic resins could potentially be used.

The plastic resin capsules can be manufactured by plastic molding techniques such as, but not limited to, custom injection molding, rotational molding, blow molding, including extrusion and continuous extrusion blow molding, injection molding, and thermoforming molding. The present invention utilizes the blow molding process for quality and production cost reasons. Other methods such as custom injection molding could also be used in the present invention production process. Blow molding produces the plastic capsule in one part and does not require fusing two parts together. This increases the quality and reduces the chance of the present invention leaking, prematurely breaking, and preventing product problems. Blow molding is also a very fast and cost effective method to mold plastic on a large scale. The process for the present invention begins with the plastic polymer resin being added to the blow molding machine and heating the resin to a fluid state. The fluid plastic is then extruded, blown, and molded into the shape and size of the desired capsule. The one-piece hybrid plastic capsule is then released out of the mold, and the concrete admixture is filled either by hand or machine through an opening in the capsule. The capsule opening is then sealed by hand or machine to prevent any leakage. Sealing materials could include, but not limited to glue, plastic, epoxy, ceramic, rubber, or adhesive strips. The plastic resin capsule wall thickness can range between approximately 1/96 inch and 1/2 inch. The present invention capsule wall thickness is approximately 1/24 inch. Any suitable plastic resin compound that is durable and does not have the tendency to crack or rupture easily, but once broken has brittle qualities, can be used to produce the capsule for the present invention. The plastic resin capsule can be in any shape or color, and range in size to hold approximately 1 ounce to 128 ounces. The plastic resin used in the present invention is a preferred embodiment because it is chemically inert and not harmful to the enclosed admixtures, and the plastic resin will not affect the concrete mix for which it is to be placed. Plastic resin as opposed to other materials has tremendous characteristics of being very durable and strong in the present invention's capsule form, but once mixed with concrete, ruptures and shatters taking on brittle qualities to breakup to the point where the plastic resin is unnoticeable to the unaided eye.

The cross sections in the capsule wall help the plastic capsule break down in the concrete mix. However, the shape of the capsule is not limited to an egg shape and can be effective in various forms. The capsule can be in the following geometric configurations including, but not limited to, cylinder, circle, rectangle, square, drum-shape, and oblong. The majority of concrete produced is gray and the plastic resin used in the present invention is tinted gray to benefit the user. The plastic resin capsule will range in size to meet the dosage desired in ounces, but will only be the size required to fill the capsule, which ranges from approximately 1 ounce to 128 ounces. The capsule generally should only be large enough to hold the dosage needs.

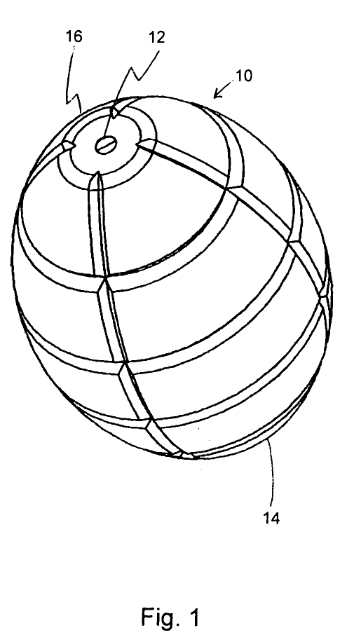

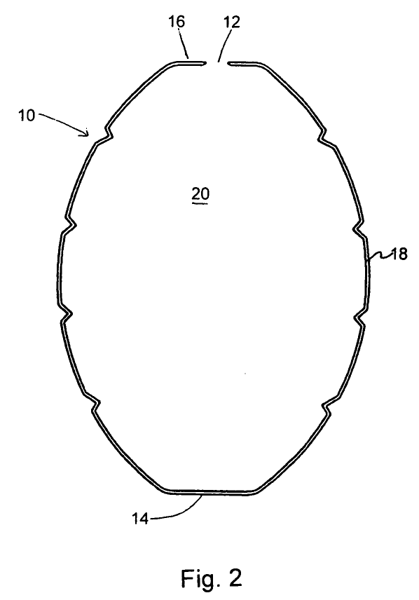

Referring to FIG. 1 in conjunction with FIG. 2, there is shown various views of the Delivery And Dispensing Capsule. Referring to FIG. 1 there is shown a perspective view of the Delivery And Dispensing Capsule. Referring to FIG. 2 there is shown a cross-section side view of the Delivery And Dispensing Capsule. Similar elements are assigned the same numbers in the various figures.

Referring in particular to FIG. 1, the entire capsule 10 can be clearly seen in the shape of an egg that is flat on bottom and on top with a sealed opening, upright, and filled completely with an admixture. The top of the capsule 16 contains opening 12 where the admixture is filled through an opening and then the capsule (egg) is sealed or plugged with glue, epoxy, plastic, rubber, ceramic, or an adhesive strip to completely enclose the admixture inside the capsule.

Referring to FIG. 2 the bottom 14 of the capsule 10 and how the cross-sectioned egg shape capsule is flat on bottom 14 to allow the capsule 10 to stand upright for packaging and stabilization purposes. The capsule 10 is shown in cross-section. The particular shape and grooving help the capsule break down in a concrete mix. Each cross-section line on the capsule is grooved in and thus promotes areas that allow rocks in the concrete mix to push into the capsule wall and cause fracture points. This enables the capsule 10 to begin breaking down in a concrete mix. It should be noted that the egg shape capsule is thinner at the base, increasing in width towards the middle of the capsule 10, and decreases in width towards the top of the egg shaped capsule. The capsule 10 is in the shape described because the egg-like shape sits in the palm of a hand more comfortably, and also because the egg is stabilized better to stand on its own due to the base being flat. This utilitarian design for the capsule is aesthetically appealing for shipping and packaging purposes, and for daily use of the present invention.

The thin plastic resin wall 18 of the capsule 10 is shown and when the admixture 20 is contained within the capsule 10 the opening 12 is sealed whereby the admixture is encased in the capsule.

Notably, the present invention relates to a device having a pre-measured dosage of liquid concrete admixture contained within this capsule formed of plastic resin such that when the plastic resin capsule containing this concrete admixture is introduced into a wet concrete mix and agitated, the plastic resin capsule is engineered to shatter and break down, and release the concrete admixture into the wet concrete mix. The engineered plastic resin dispensing capsule containing a pre-measured dosage of admixture is introduced into concrete ready-mix trucks and mechanically mixed, thereby agitating the concrete mix within the ready-mix truck, causing the plastic resin dispensing capsule to shatter into unnoticeable pieces and releasing the admixture into the concrete mix.

The present invention is designed to be used by concrete ready-mix producers and concrete contractors. The applicability, versatility, and ability of being able to use a plastic resin capsule that will shatter, become unnoticeable to the unaided eye upon agitation in a concrete mix via a concrete ready-mix truck, and then releasing a pre-measured dosage of concrete admixture within the concrete mix is very desirable.

Unlike the present common practice of adding admixture to a concrete mixture via a bulk concrete mixing station, or via tanks mounted on the side of the concrete ready-mix trucks that release admixtures through hoses into the concrete mix, the present invention capsule permits pre-measured doses to be available for use at the plant as well as in the field as necessary. The present invention is also in contrast to the practice of adding a solid or powdered admixture in a water soluble container, such as polyvinyl alcohol, polyethylene oxide, foam, cellulose, paper products, and cotton products. The present invention delivers liquid admixtures into concrete mixes by way of a plastic resin capsule device that shatters upon agitation. The plastic resin is not water sensitive or dependent upon water to break the capsule down to release the concrete admixture. The present invention is also in contrast to a capsule formed of a water soluble material, including gelatin, glass, polyethylene and other materials such as wax due to the packaging container encapsulating the concrete admixture being a plastic resin.

The present invention is an economical, efficient, and simplified solution for concrete ready-mix producers and concrete contractors. The present invention simplifies the dosage amounts of concrete admixtures for ease of use, and allows the concrete ready-mix producer and contractor to introduce pre-measured amounts of liquid admixture into their concrete mixes by way of a plastic resin capsule without having to use a batch plant, or a tank mounted on the side of a truck that is inefficient and involves guesswork. The present invention also eliminates the problems associated with dispensing devices that releases admixtures into concrete that are temperature sensitive, water sensitive, and do not break down completely to the unaided eye in the concrete mix. The present invention uses a plastic resin formulated capsule that offers extensive value at introducing admixtures into ready-mix concrete because of the ability of the plastic resin to break down unnoticeable to the unaided eye, yet durable enough in capsule form to not leak, crack, or rupture prior to being placed in a concrete mix and agitated.

The National Ready Mix Concrete Association describes admixtures in the Concrete in Practice Series (CIPS) #15 (which is incorporated by reference herein as if fully set out in detail) as natural or manufactured chemicals added to concrete before or during mixing. The present invention can be used to dispense a range of liquid admixtures into concrete according to CIPS #15 including, but not limited to, retarding or delay setting, air entrainers, air detrainers, accelerate setting, corrosion inhibitors, admixtures to reduce potential for alkali aggregate reactivity, bonding admixtures, water-reducers, super plasticizers (high range water reducers), shrinkage reducing admixtures, anti-washout admixtures, hydration stabilizing or extended set retarding admixtures, pumping aids, natural and synthetic coloring admixtures, damp proofing, grouting agents, gas forming agents, permeability reducers, fibers, and others.

The present invention capsule enables a new method for allowing ready-mix concrete producers to effectively recycle and resell concrete in another order that has already been sold. The plastic resin capsule containing the pre-measured dosage of liquid retarder or delay setting chemicals can be used to change the properties of leftover concrete in the field, allowing the concrete to be re-sold in another load of concrete that has similar specifications. In general, excess concrete is sent back to the bulk manufacturing plant and is wasted by being dumped in large mounds, only later to be crushed. Other uses for excess concrete have included the production of large concrete blocks, but the market value of the concrete in this form tremendously decreases. The present invention's advanced technology of ease of use, simplified dose measurements, and a dispensing capsule that completely breaks down unnoticeably in the concrete mix gives ready-mix producers a new economical method of reselling recycled concrete at market value, while preventing the environmental impact that is associated with waste concrete.

The present invention method recycles leftover concrete to re-sell in another order at market value by immediately dosing the returned concrete in the field with a delivery and dispensing device(s) encapsulating a pre-measured dosage of a fluid, semi-fluid, dry retarding, or delay setting admixture designed to accurately slow the hydration rate of leftover concrete.

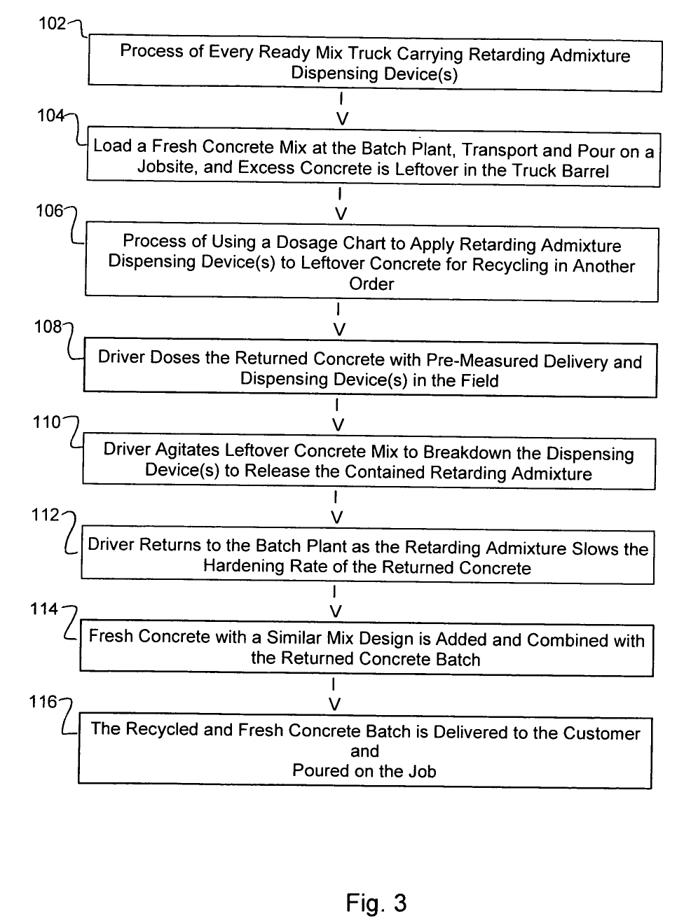

Referring to FIG. 3 there is shown a diagrammatic representation of the process for recycling concrete. This demonstrates the entire present method's process of successfully recycling leftover concrete for the specific purpose of re-selling in another order. The process put forth is a basic template of steps for the present method.

Step 102 identifies every ready-mix truck in a producer's fleet carrying retarding admixture delivery and dispensing devices. The ready-mix producer will have a storage area at the batch plant containing a stock of multiple unit packages of delivery and dispensing devices containing a pre-measured dosage of retarding admixture. A ready-mix truck driver can take from this storage to ensure their truck is properly stocked with enough retarding admixture delivery and dispensing devices to handle any leftover concrete range at a time in the field. The dispensing devices can be packaged together in multiple units to easily carry many units at a time, and protect the encapsulating devices from weather and breaking due to rugged ready-mix truck transportation.

Step 104 recognizes the present method's step of loading fresh concrete mix at the batch plant, transporting and pouring the load on the jobsite, and having excess concrete leftover in the truck barrel. In this step, a concrete batch is delivered to a customer on a jobsite, and the customer does not use the entire order. The customer still pays for the entire delivery, but returns the leftover concrete to the ready-mix producer for them to dispose at their discretion. The returned concrete at this point is approximately 1 hour +/−15 minutes old. The concrete will typically begin its initial set without the presence of a retarding admixture within 1 hour and 30 minutes of production.

Step 106 establishes the step of using a dosage chart to apply retarding admixture delivery and dispensing device(s) to leftover concrete in the field for recycling in another customer order. The driver will notify the ready-mix producer dispatch center of the estimated leftover concrete amount, and dispatch will search their delivery schedule for an upcoming order to recycle and re-sell the returned concrete. The dispatch center will look for a concrete batch that will have a similar mix design considering cement content and p.s.i. strength. Once dispatch finds an order, they or the driver, will refer to a dosage chart to accurately retard the 1 hour+1−15 minute old leftover concrete mix for approximately 2 to 2% 2 hours. The extended set time for the returned concrete will give the driver enough time to return to the batch plant, load and mix fresh concrete with the recycled concrete, and deliver and pour the batch on the following jobsite.

Step 108 is the next step showing the driver dosing the returned concrete with a pre-measured retarding admixture delivery and dispensing device(s) in the field prior to returning to the batch plant for loading fresh concrete. The driver will add the retarding admixture device directly to the returned concrete in the ready-mix truck barrel. A major point of the present method is accurately and immediately dosing the leftover concrete in the field. This maintains the quality of the returned concrete to avoid any problems with deterioration due to the concrete hydrating and a setup earlier than desired.

Step 110 identifies the step of the driver agitating the fluid or semi-fluid leftover concrete mix in the truck barrel to break down the dispensing device(s) unnoticeably to the unaided eye, and thereby releasing the contained retarding admixture into the returned concrete mix.

Step 112 refers to the driver returning to the batch plant as the retarding admixture slows the hydration rate of the returned concrete. The present method introduces this new technique for re-selling returned concrete as it allows the returned concrete set time to slow down prior to adding fresh concrete in the truck barrel. Slowing the hydration of approximately 1 hour+/−15 minute old leftover concrete for 2 to 2'/2 hours will extend the set time to approximately the same rate as adding fresh concrete.

Step 114 refers to fresh concrete with a similar mix design being added and combined with the returned and treated concrete batch in the truck barrel. The two most typical mix designs ordered by a concrete customer are either 3,000 p.s.i. or 4,000 p.s.i. Fresh concrete is loaded into the ready-mix truck on top of the recycled concrete at the batch plant. The entire concrete load is then agitated via the ready-mix truck mixing the recycled concrete and the fresh concrete together.

Step 116 establishes the present method step of the recycled and fresh concrete mixed batch being delivered to the customer and poured on the job. The returned concrete is recycled and re-sold at the fresh concrete market price with minimal investment and labor.

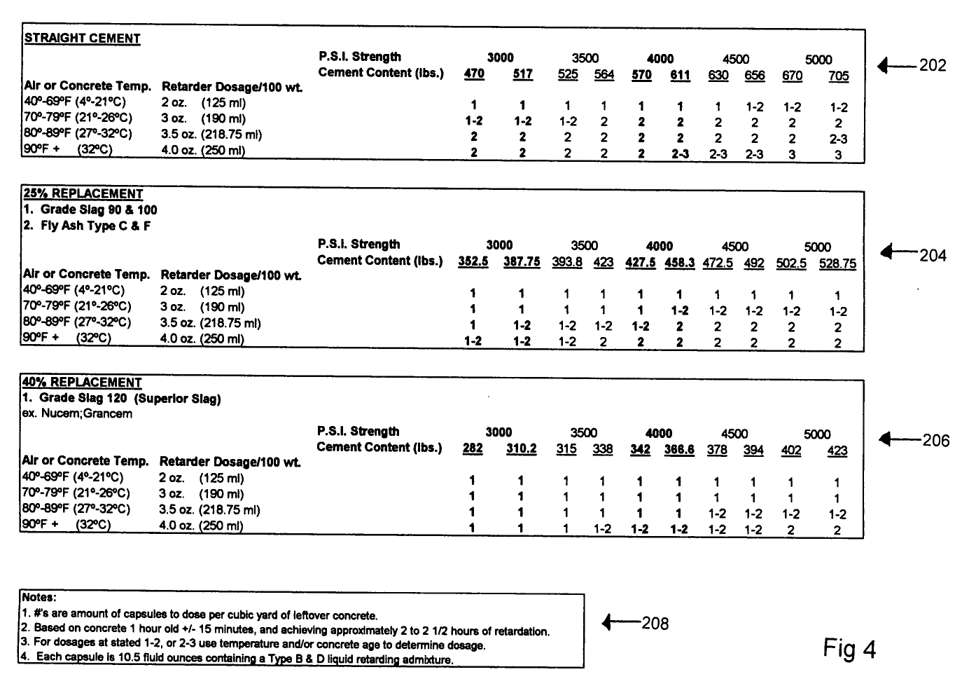

Referring to FIG. 4, there is shown a chart of admixture dosing, and in particular a retarding admixture delivery and dispensing device dosage chart for the present method. This is the chart a ready-mix producer dispatch center or truck driver will refer to in accurately dosing the returned concrete with delivery and dispensing device(s) containing a pre-measured quantity of retarding admixture.

The characteristics of the charts 208 assumed to reach a retarding admixture dosage rate include: the resulting numbers on the chart are the amount of retarding admixture device(s) to dose a cubic yard of leftover concrete, the leftover concrete is 1 hour+/−15 minutes old and achieves 2 to 2% 2 hours of retardation, the stated 1-2, or 2-3 dosages should use temperature and/or concrete age to determine a more defined dosage, and each capsule contains 10.5 fluid ounces of a Type B & D liquid retarding admixture.

Chart 202 refers to a delivery and dispensing device dosage table considering variables such as straight cement powder with no pozzalans in a concrete cubic yard, concrete p.s.i. strength, pounds of cement per cubic concrete yard, retarding admixture dosage per 100 pounds of cement, and either the air or concrete temperature.

Chart 204 refers to a delivery and dispensing device dosage table considering variables such as a 25% cement powder replacement filler (Grade Slag 90 & 100, Fly Ash Type C & F) in a concrete cubic yard, concrete p.s.i. strength, pounds of cement per cubic concrete yard, retarding admixture dosage per 100 pounds of cement, and either the air or concrete temperature.

Chart 206 refers to a delivery and dispensing device dosage table considering variables such as a 40% cement powder replacement pozzalan (Grade Slag 120) in a concrete cubic yard, concrete p.s.i. strength, pounds of cement per cubic concrete yard, retarding admixture dosage per 100 pounds of cement, and either the air or concrete temperature.

The present method is an economical, efficient, and simplified solution for concrete ready-mix producers to recycle leftover concrete and maximize the leftover concrete value by re-selling it in another order with fresh concrete. The present method is in contrast to the common practice of recycling returned concrete in block form shapes, and also the practice of pouring returned concrete into waste piles to be crushed for fill.

The present method is in contrast to the method of recycling returned concrete by loading fresh concrete on top of the returned concrete mix at the batch plant and re-selling in another order. The present method doses leftover concrete with a delivery and dispensing device containing a pre-measured amount of retarding admixture in the field prior to returning to the batch plant and loading fresh concrete. The concrete mix is agitated causing the delivery and dispensing device to break down and releases the retarding admixture, which will slow the hydration rate of the returned concrete load prior to adding fresh concrete.

The present method is in contrast to the method of adding a retarding admixture with fresh concrete at the batch plant to the returned concrete batch. The present method adds a retarding admixture via a delivery and dispensing device in the field prior to arriving at the batch plant and loading fresh concrete to the leftover concrete batch. This is an important step in successfully recycling quality leftover concrete that is not currently being utilized by ready-mix producers in the concrete industry.

The present method is different than the technique of having a tank mounted on a ready-mix truck that is specifically designed for dosing a single concrete load size with a high range water reducer admixture. The tank mounted method is also an all-or-nothing method that is not designed for dispensing measured dosages of retarding admixture across multiple loads. The present method adds a packaging device containing a retarding admixture directly into a leftover concrete mix, whereas the mounted tank holds the admixture and injects it into the truck barrel.

The present method is in contrast to Smith et al., U.S. Pat. No. 4,961,790, which discloses a dispensing method for a measured amount of solid or dry admixtures utilizing a water soluble package that once introduced into a concrete mix, dissolves thereby releasing the admixture into the mix. The Smith et al. patent specifically patents the use of a water soluble package to form the delivery and dispensing device, and not the specific method of the present invention. The Smith et al. patent is marketed and used for dosing entire single freshly batched concrete mixes prior to pouring on a specified job. The present method is designed for dosing leftover concrete mixes after pouring on a specified job, and re-selling the returned concrete in another order.

The present method is different than de Mars et al., U.S. Pat. No. 5,320,851, which discloses a method for introducing liquid admixtures, specifically air entrainment admixture, into concrete mixes in a dispensing package formed specifically of wax, and not the specified method of the present invention. The de Mars et al. wax delivery and dispensing capsule has only been manufactured encapsulating an air entrainment admixture and is packaged in bulk boxes. The present method utilizes a delivery and dispensing device that specifically encapsulates a retarding admixture, and is packaged to be carried on every ready-mix truck in a producer's fleet.

The present method addresses the variables required to successfully recycle and re-sell leftover concrete at market value in another order with fresh concrete, which plagues concrete ready-mix producers. The trick to re-selling returned concrete is dosing the batch with a retarding admixture in the field prior to loading fresh concrete at the batch plant. The leftover concrete hydration rate must be slowed immediately to prevent deterioration, which can lead to poor quality concrete, repair costs, and having to tear out and replace poured recycled concrete on a jobsite. The present method addresses the caveats of dosing leftover concrete in the field. The present method utilizes a method avoiding intensive labor, time, and manufacturing requirements by using a delivery and dispensing device containing a pre-measured dosage of retarding admixture that is packaged in multiple unit containers for every ready-mix truck in a producer's fleet to easily and economically carry on a truck in the field. The entire delivery and dispensing device containing the retarding admixture is added to the concrete mix. The concrete mix is agitated causing the packaging device to completely break down unnoticeably to the unaided eye thereby releasing the retarding admixture that will disperse throughout the leftover concrete batch. The present method also uses a delivery and dispensing device dosage chart to avoid any ambiguous or inaccurate dosing, and does not require any calculations to dose the returned concrete with a retarding admixture. The present method avoids a lower market value in the form of blocks and filler, and does not dump leftover concrete on the ground into waste piles that have harsh environmental implications.

The National Ready-Mix Concrete Association describes admixtures in the Concrete in Practice Serifs (CIPS) #15 as natural or manufactured chemicals added to concrete before or during mixing. CIPS #15 also states retarders are chemicals which delay the initial set of concrete by an hour or more. Most retarders also act as water reducers. Retarders are covered by ASTM C 494² Types B and D.

This method can be better understood by looking at exemplary descriptions of its use which follow.

### EXAMPLE 1

The following is a sales proposal and description of the present method pertaining to the value of recycling returned concrete to re-sell in another order at market value.

Every ready-mix truck in a concrete producer's fleet will carry 2 to 3 boxes, each having 6 delivery and dispensing devices encapsulating 10.5 fluid ounces of a Type B and D liquid retarding admixture. The driver will always be able to handle an estimated range of 1 to 6 leftover concrete cubic yards at a given time in the field. The efficient-sized boxes can fit inside a ready-mix truck cab to help deter any of the devices breaking while being transported. The 6-unit package size is not too large as opposed to having 12 units per package, which would lead to a problem of a box left with a few capsules. It's very bulky to carrying two large, 12 unit, boxes to ensure enough devices in the field. The ready-mix producer can have a pallet of 6 unit boxes in supply and allow drivers to restock their truck as needed.

The time is 12:00 p.m. and the temperature is approximately 82° Fahrenheit. A driver loads 11 cubic yards of concrete with a mix design of 4,000 p.s.i. strength and 611 pounds of straight cement per cubic yard. The driver spends 30 minutes driving to the jobsite and another 15 minutes pouring the load on the job. The customer ordered an excess of 1 yard to ensure he can finish the concrete pour, but sends the leftover concrete back to the ready-mix producer even though he purchased it at approximately $65 per cubic yard. The time is now 12:45 p.m. and the leftover concrete is 45 minutes old since it was manufactured. The returned concrete will begin to set an hour and a half after production, which leaves the driver 45 minutes to pour the leftover yard. The driver notifies the dispatch center of the leftover 1 cubic yard and asks for guidance on what to do with it. The dispatch center looks for an upcoming order on their schedule to re-sell the returned concrete. Dispatch finds another order with a mix design of 4,000 p.s.i strength concrete and 611 pounds of straight cement per cubic yard. The dispatch center refers to the delivery and dispensing device retarding admixture dosage chart. Please see FIG. 2 for an example. The dispatcher refers to the straight cement table, and finds the capsule dosage rate lining up with 82° Fahrenheit, and a mix design of 4,000 p.s.i. with 611 pounds of cement. The chart states 2 capsules should be added to the leftover 1 cubic yard to extend the set time for 2 to 2½ hours. Now the driver is not bound to 45 minutes to use the leftover concrete, and has time to return to the plant to load fresh concrete on top of the recycled concrete and pour on another job. The chart requires no thought on the driver's behalf, and no calculations for the dispatcher. The capsule dosage rate chart already calculates to dose 611 pounds of cement per cubic yard at the 3.5 ounces per 100 weight of cement (due to the air temperature), requires 21.3 ounces of retarding admixture. Each capsule contains 10.5 ounces of retarding admixture, thus 2 devices at 21 ounces will meet the dosage needs.

The dispatcher quickly notifies the driver to dose the leftover yard with 2 capsules that he is carrying on his truck. The driver then adds the delivery and dispensing devices into the concrete mix and mechanically agitates the load. The delivery and dispensing devices are broken down unnoticeably in the leftover concrete mix and the encapsulated pre-measured retarding admixture is released. It will be approximately 15 minutes as the driver does this step and is ready to leave the jobsite after washing wet concrete off the truck. The time will be approximately 1:00 p.m. and the leftover concrete will be about 1 hour hydrated and have a 2 to 2'/2 hour window before it has to be poured.

As the driver is returning to the batch plant, the truck barrel is turning and mixing the retarding admixture throughout the returned concrete batch, and exponentially breaking down the delivery and dispensing device into unnoticeable pieces. The driver takes 30 minutes to get back to the batch plant and the time is 1:30 p.m. The dispatch center loads the driver with the new order designated to re-sell the recycled concrete, and the time is now 1:45 p.m. The recycled concrete is in the same physical state as the fresh concrete batch, as the returned batch will begin to set in approximately 1 hour 15 minutes to 1 hour 45 minutes. As the driver is delivering the order, the ready-mix truck barrel is constantly turning the concrete batch thoroughly mixing the recycled and fresh concrete. The entire fresh and recycled batch should be poured on the following job by 3:30 p.m.

The recycled concrete will be sold a second time at full market value of approximately $65 per cubic yard and at a cost of approximately $5.00 ($2.50 per capsule). The problems associated with other methods of using returned concrete are avoided with minimal investment. Concrete setup time, or the hydration rate, is not an exact science and may vary within the estimated ranges given due to variables such as ambient temperature, concrete temperature, weather conditions, and many others.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications, which come within the scope of the appended claim, is reserved.

1. A method for recycling concrete by a ready-mix concrete producer, the method comprising the following steps:
providing a dispensing capsule body containing a pre-measured dosage of semi-fluid or fluid, dry retarding, or delay-setting admixture;
carrying said dispensing capsule on ready-mix trucks in a producer's fleet,
introducing said dispensing capsule body into a ready mix truck containing leftover concrete;
agitating said leftover concrete wherein said hollow plastic capsule body releases said admixture;
thereby allowing the concrete mix to be recycled in a subsequent load of concrete mix.

2. The method for recycling concrete by ready-mix concrete producers as recited in claim 1 wherein the step of introducing said dispensing capsule body further comprises determining dosage as a function of weight of leftover cement and temperature.

3. The method for recycling concrete by ready-mix concrete producers as recited in claim 2 wherein the step of introducing said dispensing capsule body further comprises determining dosage as a function of percentage of replacement.

4. The method for recycling concrete by ready-mix concrete producers as recited in claim 2 wherein temperature corresponds to leftover concrete temperature.

5. The method for recycling concrete by ready-mix concrete producers as recited in claim 2 wherein temperature corresponds to ambient air temperature.

6. The method for recycling concrete by ready-mix concrete producers as recited in claim 1 further comprising the step of returning the leftover concrete to the ready-mix concrete producer.

7. The method for recycling concrete by ready-mix concrete producers as recited in claim 1 wherein said dispensing capsule is inert to the admixture and the concrete mix.

8. The method for recycling concrete by ready-mix concrete producers as recited in claim 1 wherein said dispensing capsule has a thickness of between approximately 1/96 of an inch to approximately 1/2 of an inch.

9. The method for recycling concrete by ready-mix concrete producers as recited in claim 1 wherein said dispensing capsule is shattered and fractured by the mechanical agitation of the concrete mix into a size unnoticeable to the unaided eye.

10. The method for recycling concrete by ready-mix concrete producers as recited in claim 1 wherein said dispensing capsule is impact-adjusted crystal polystyrene.

11. The method for recycling concrete by ready-mix concrete producers as recited in claim 10 wherein said impact-adjusted crystal polystyrene is comprised of standard fillers blended into basic polystyrene resin whereby the polystyrene molecule chains separate and weaken.

12. The method for recycling concrete by ready-mix concrete producers as recited in claim 1 wherein said dispensing capsule market value is the price of fresh concrete with same mix design.

13. The method for recycling concrete by ready-mix concrete producers as recited in claim 1 wherein said dispensing capsule is packaged to be carried on the ready-mix truck.

14. The method for recycling concrete by ready-mix concrete producers as recited in claim 13 wherein the ready-mix truck are all trucks that transport and pour concrete to a customer in a producer's fleet.

15. The method for recycling concrete by ready-mix concrete producers as recited in claim 1 wherein the step of introducing said dispensing capsule body further comprises determining dosage as a function of presence of pozzalan replacement.

16. The method for recycling concrete by ready-mix concrete producers as recited in claim 1 wherein said released retarding admixture slows hydration rate of the leftover concrete prior to mixing fresh concrete.

17. The method for recycling concrete by ready-mix concrete producers as recited in claim 1 wherein said released retarding admixture slows hydration rate of the leftover concrete prior to delivering a recycled and fresh concrete batch to a customer.

18. The method for recycling concrete by ready-mix concrete producers as recited in claim 1 wherein said dispensing capsule market value is the price of fresh concrete with weaker mix design.

19. The method for recycling concrete by ready-mix concrete producers as recited in claim 1 wherein said recycled concrete has the same mix design as a subsequent load of concrete mix.

20. The method for recycling concrete by ready-mix concrete producers as recited in claim 1 wherein said recycled concrete has a stronger mix design than a subsequent load of concrete mix.
